(19) United States
(12) Patent Application Publication
(10) Pub. No.: US 2016/0275268 A1
(43) Pub. Date: Sep. 22, 2016

(54) SYSTEMS AND METHODS FOR IMPLEMENTING ANESTHESIA PRE-OPERATIVE PROCEDURES AND TRACKING AUTOMATION TECHNIQUES

(71) Applicant: Plectics Medical Solutions, Inc., Greenville, NC (US)

(72) Inventor: Perrin Jones, Greenville, NC (US)

(21) Appl. No.: 15/074,006

(22) Filed: Mar. 18, 2016

Related U.S. Application Data
(60) Provisional application No. 62/135,385, filed on Mar. 19, 2015.

(51) Int. Cl. G06F 19/00

(52) U.S. Cl. CPC G06F 19/363; G06F 19/322

(57) ABSTRACT

Systems and methods for implementing anesthesia pre-operative and tracking automation with a computing device are disclosed herein. According to an aspect, a method comprises using at least one processor and memory for executing a standardized anesthesia pre-operative algorithm. The method further includes determining known medical data in at least one database associated with a patient. The method also includes acquiring known medical data from the at least one database. The method also includes querying a user for new medical data based on determining known medical data using a data entry device. The method also includes determining data is one of new and known medical data. The method also includes in response to determining the data is one of new and known medical data, providing a list of appropriate medical procedures to be performed.

### CROSS-REFERENCE TO RELATED APPLICATIONS

This application claims the benefit of U.S. Provisional Application No. 62/135,385, filed Mar. 19, 2015, the entire content of which is incorporated by reference herein in its entirety.

### TECHNICAL FIELD

The present disclosure relates to implementation of anesthesia pre op procedures, and more specifically, to systems and methods for implementing anesthesia pre-operative procedures and tracking automation techniques with a computing device.

### BACKGROUND

Patients require laboratory and other testing prior to their surgical procedure. The availability of this information for anesthesiologist review is important for both patient safety and Operating Room efficiency. Standardized pre-operative testing checklists are available but the implementation of these checklists is inconsistent. This inconsistency leads to expensive, duplicative testing and increases the likelihood of either a day of surgery cancellation or delay while results are obtained.

Therefore, it is imperative that test results be thoroughly and consistently compiled in a timely manner. Clinical data acquisition must also be cost effective. There is a longstanding and growing body of evidence in the anesthesia literature arguing that a haphazard or ‘shotgun’ approach to pre-op testing is arbitrary and of limited utility with regards to patient outcomes as well as avoiding case cancellations and delays. The ability to “recycle” existing, yet clinically relevant, lab data from a patient's medical record is inconsistently used at present.

The ideal solution would utilize a standardized anesthesia pre-operative algorithm to minimize unnecessary testing without negatively impacting patient care. The ideal solution would also query existing clinical databases to determine whether necessary test results already exist and, in conjunction with anesthesiologist derived clinical logic, determine if the existing data is clinically relevant and capable of being used in the pre-operative assessment. The solution would also be able to track ‘new’ versus ‘recycled’ test results as a means to track cost savings created by the system. The ability to track “new” versus “recycled” labs would be important financially as the difference could be monetized and then distributed to relevant parties utilizing a merit based methodology. Finally, the solution would be able to track charts. Thus, there is a need for systems and methods for implementing anesthesia pre op procedures and tracking automation techniques with a computing device.

### SUMMARY

Described herein are systems and methods for implementing anesthesia pre-operative and tracking automation with a computing device. According to an aspect, a method comprises using at least one processor and memory for executing a standardized anesthesia pre-operative algorithm. The method further includes determining known medical data in at least one database associated with a patient. The method also includes acquiring known medical data from the at least one database. The method also includes querying a user for new medical data based on determining known medical data using a data entry device. The method also includes determining data is one of new and known medical data. The method also includes in response to determining the data is one of new and known medical data, providing a list of appropriate medical procedures to be performed.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of an example system for implementing anesthesia pre-operative medical procedures and tracking automation techniques with a computing device according to embodiments of the present disclosure;

FIGS. 2A-2J is a flowchart of an example method for implementing anesthesia pre-operative medical procedures and tracking automation techniques with a computing device according to embodiments of the present disclosure;

FIGS. 3A-3E is a flowchart of an example method for implementing anesthesia pre-operative sub-specialty optimization work flow and tracking automation techniques with a computing device according to embodiments of the present disclosure; and

FIGS. 4A-4C is a set of screen displays of an example user interface for implementing anesthesia pre-operative medical evaluations and tracking automation techniques with a computing device according to embodiments of the present disclosure.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims. For example, the inventors have contemplated that the claimed subject matter might also be embodied to include different steps or elements similar to the ones described in this document, in conjunction with other present or future technologies.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

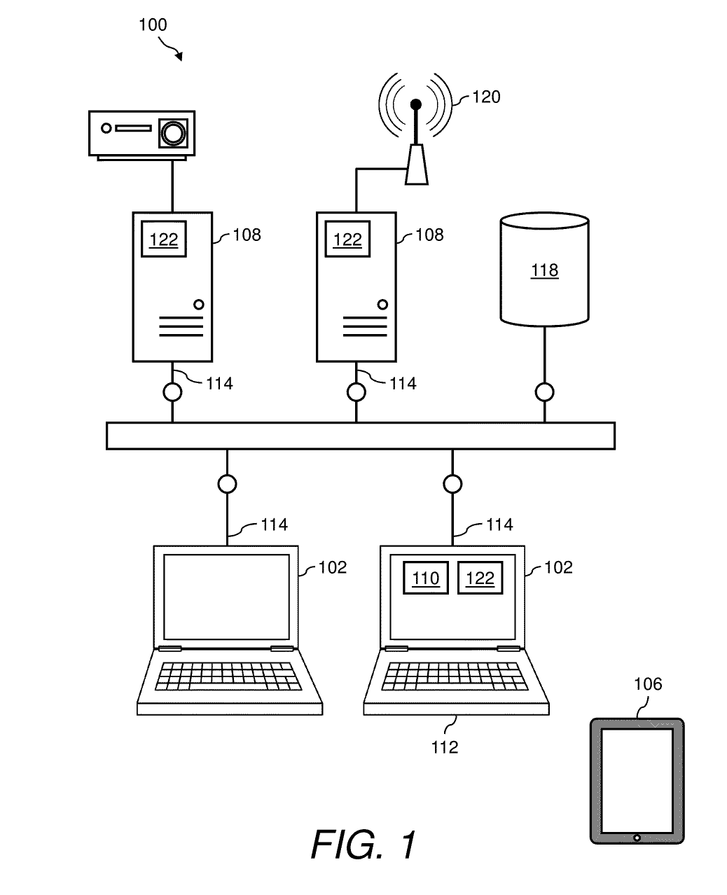

The presently disclosure is now described in more detail. For example, FIG. 1 illustrates a block diagram of a system 100 according to embodiments of the present disclosure. The system 100 may be implemented in whole or in part in any suitable computing environment. A computing device 102 may be communicatively connected via a communications network 104, which may be any suitable local area network (LAN), either wireless (e.g., BLUETOOTH® communication technology) and/or wired. The computing device 102, a tablet device 106 in communication with the computing device 102, and other components, not shown, may be configured to acquire data within the computing or data analysis environment, to process the data, and to communicate the data to a centralized server 108. For example, the computing device 102 and tablet device 106 may operate together to implement a data analysis function and to communicate data related thereto to the server 108. The server 108 may reside in a local or remote location.

The components of the system 100 may each include hardware, software, firmware, or combinations thereof. For example, software residing in memory of a respective component may include instructions implemented by a processor for carrying out functions disclosed herein. As an example, the computing device 102 may each include a user interface 110 including a display (e.g., a touchscreen display), a barcode scanner, and/or other equipment for interfacing with intelligence personnel and for conducting data analysis. The computing device 102 may also include memory 112. The computing device 102 may also include a suitable network interface 114 for communicating with the network 104. The tablet device 106 may include hardware (e.g., image capture devices, scanners, and the like) for capture of various data within the computing environment. The system 100 may also include a smart phone device 116 configured similarly to the tablet device 106. The system 100 may also comprise a database 118 for storage of grammatical rules, word and phrase definitions and meanings, as an example. Further, the server 108 may be connected to the computing devices 102 via the network 104 or via a wireless network 120.

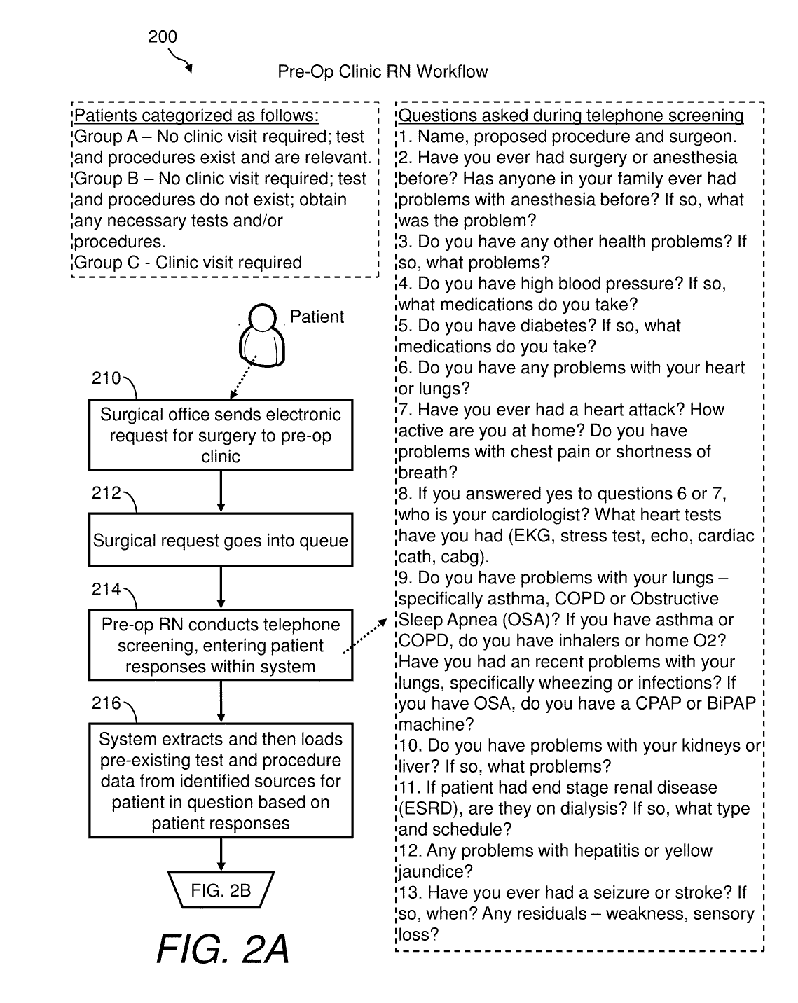

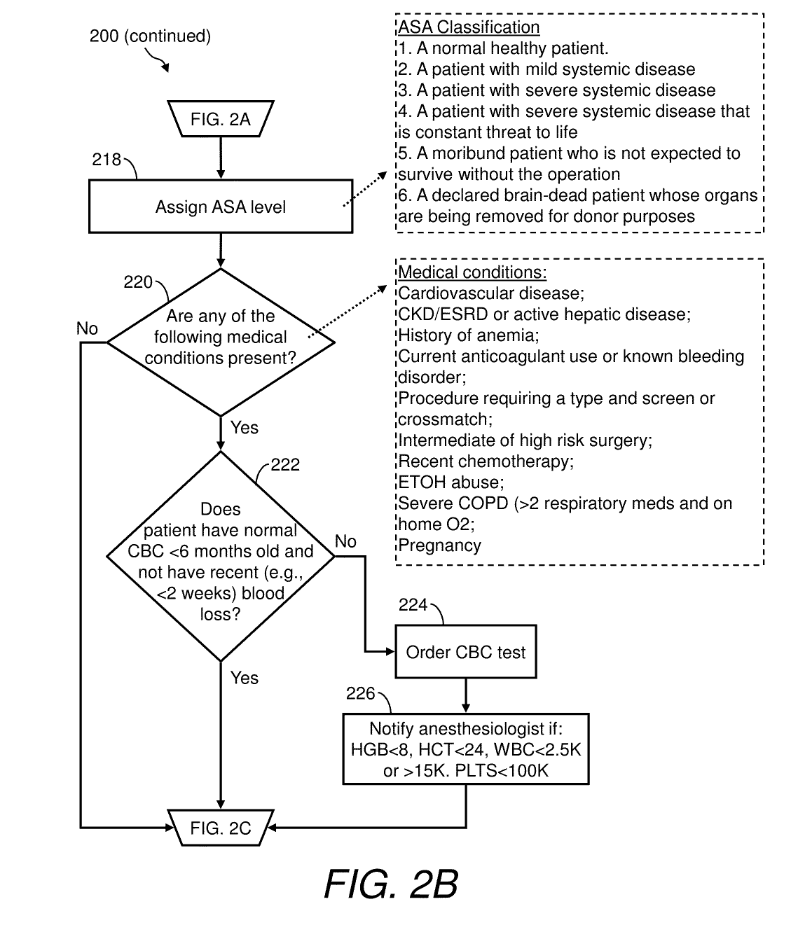

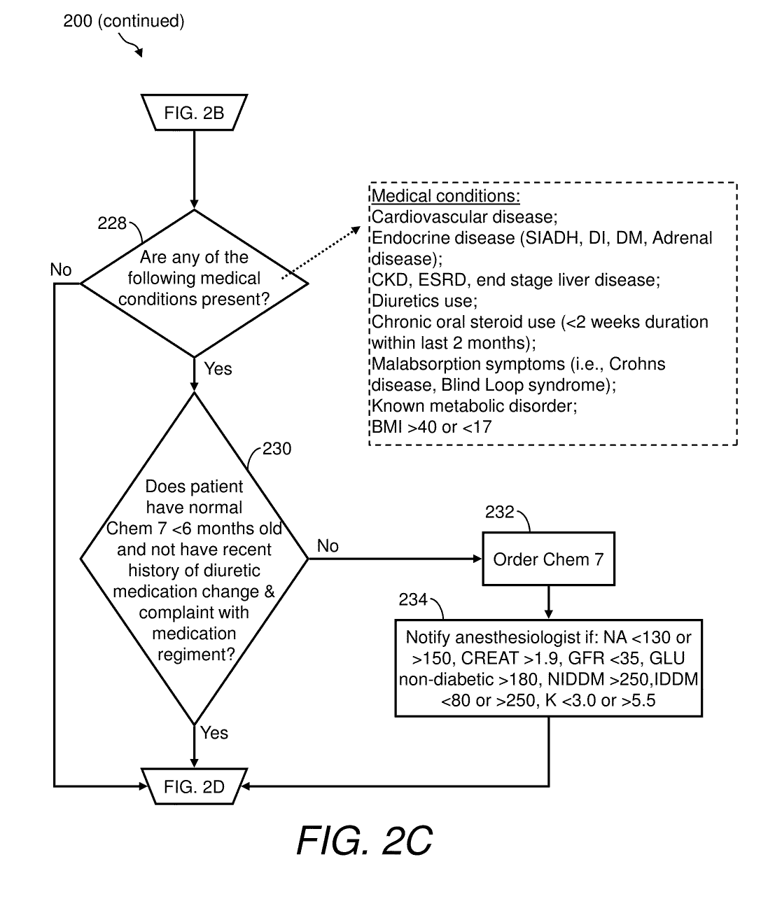

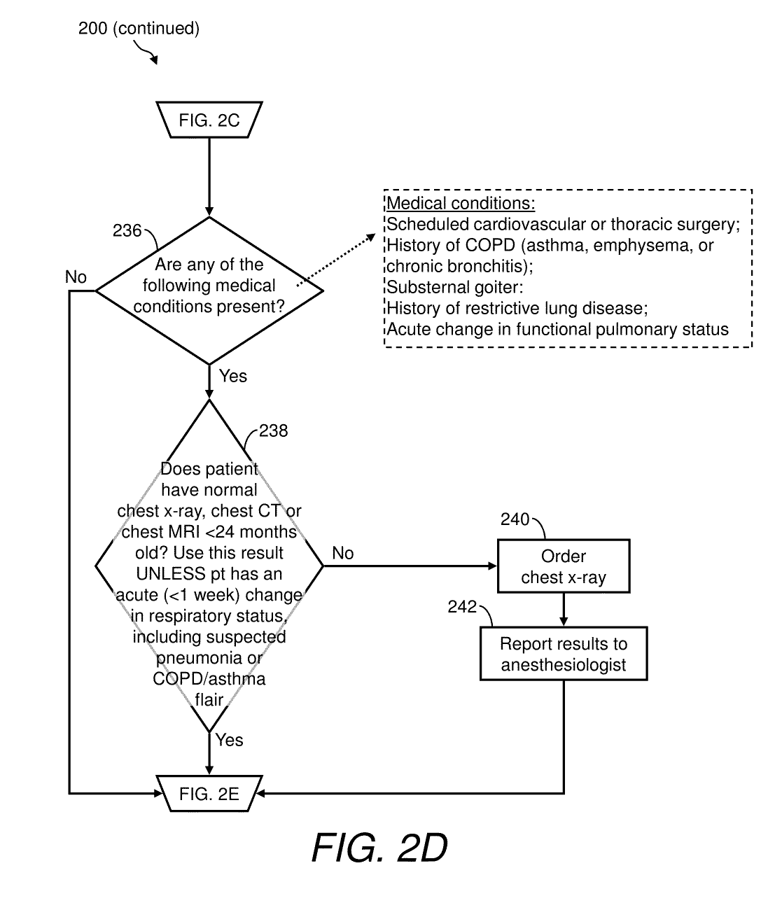

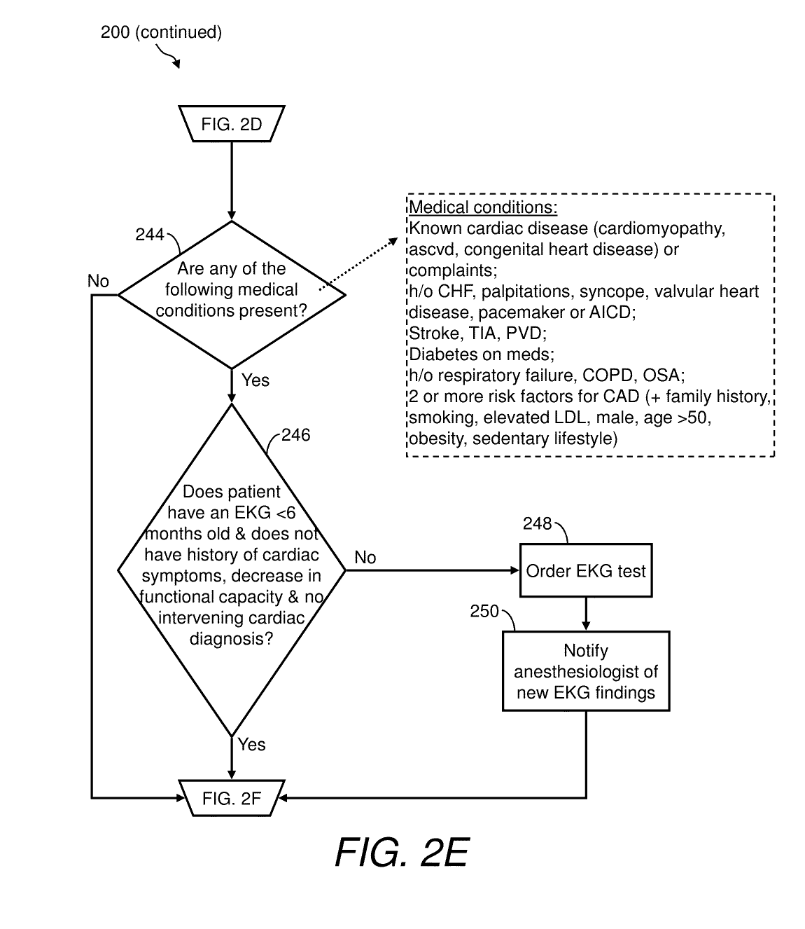

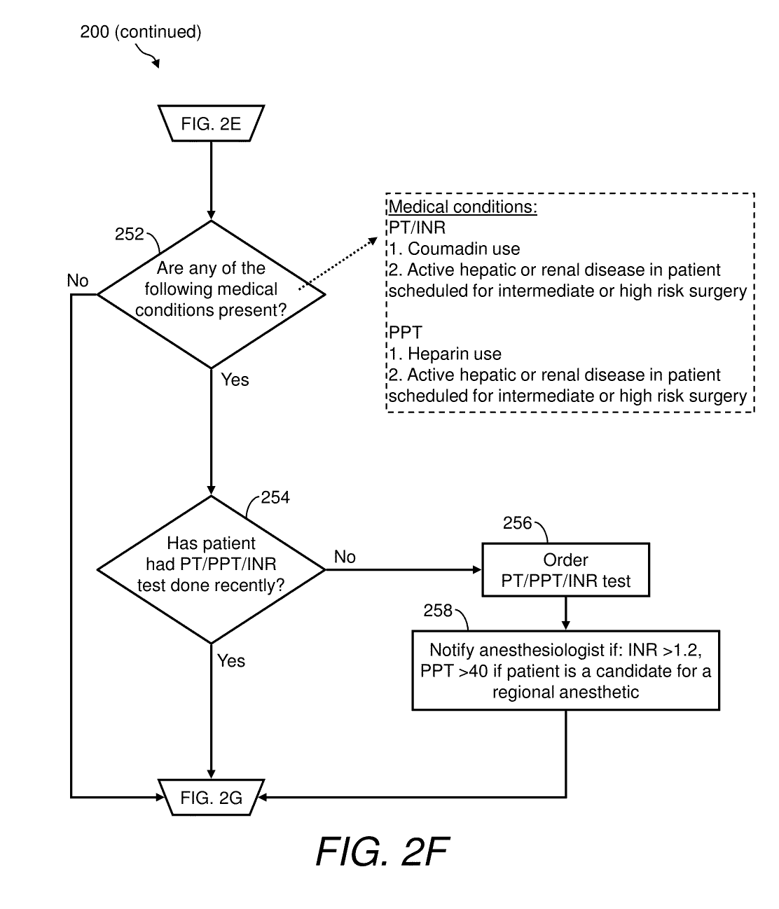

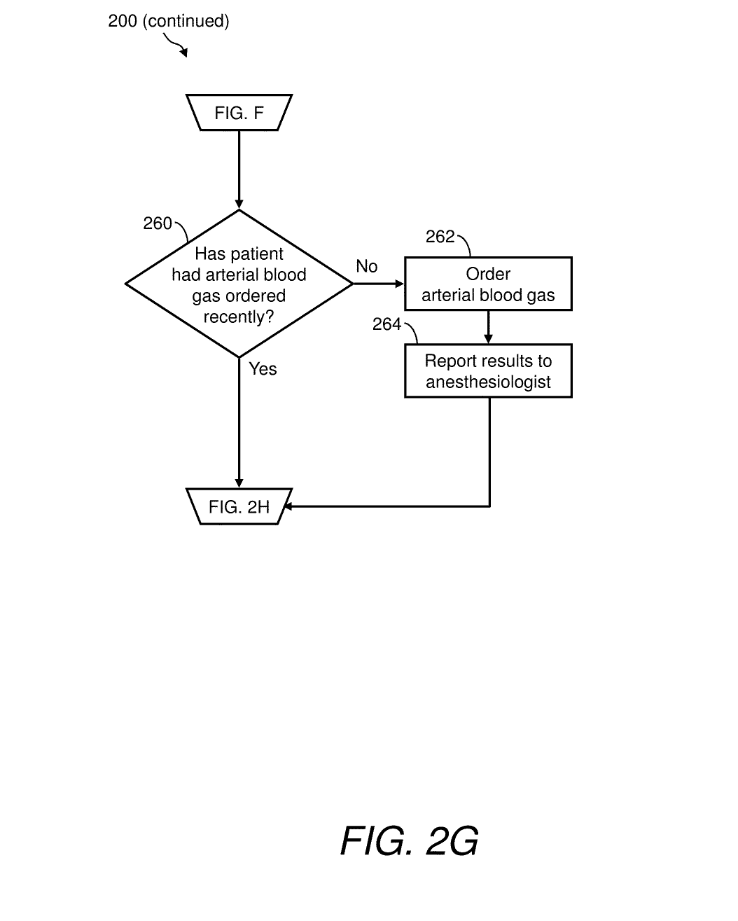

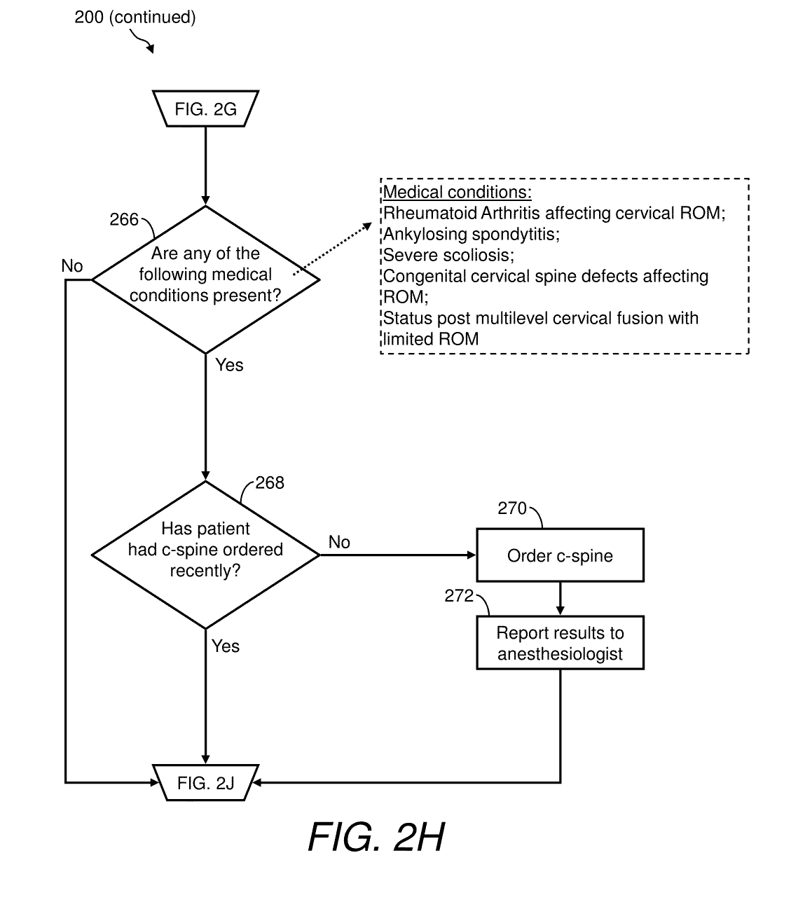

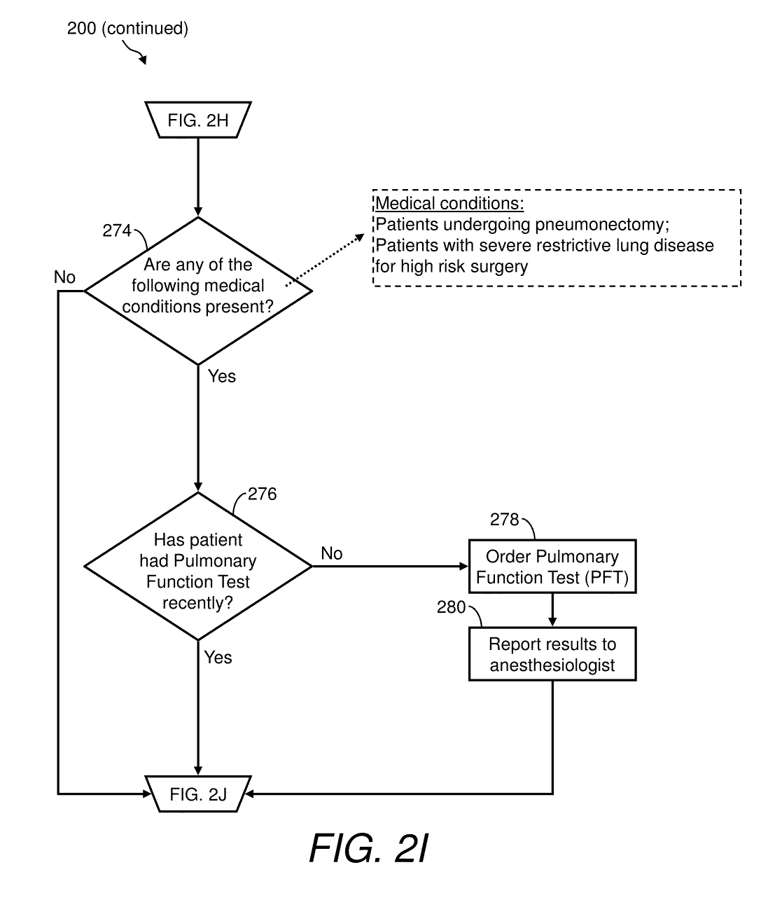

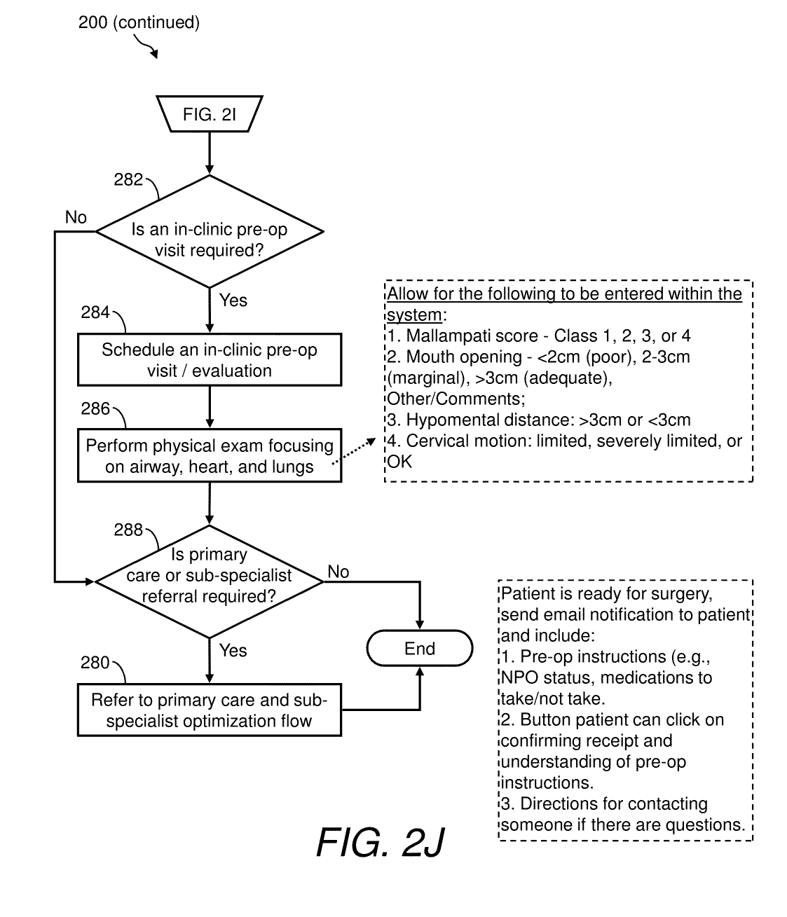

With continued reference to FIG. 1, the system 100 comprising at least a processor and memory of a computing device and an electronic medical record database 122 is provided. As will be described in further detail in FIGS. 2-4, the electronic medical record data base 122 may be configured to receive electronic test results and data associated with a patient's medical records from various sources. The database 118 may also be used to store the data feed or identified portions of the data feeds based on analysis using the tracking automation software. It should be noted that the database 118 may be located either internal or external to the servers 108.

FIGS. 2A-2J illustrates a flowchart of an example method 200 for implementing anesthesia pre-operative medical procedures and tracking automation techniques with a computing device according to embodiments of the present disclosure. In this example, the method 200 is more fully described in Examples 1-5 included herein, although it should be understood that the method 200 may alternatively be any other suitable pre-operative workflow. The method 200 may also be implemented by any suitable system 100 or computing device 102.

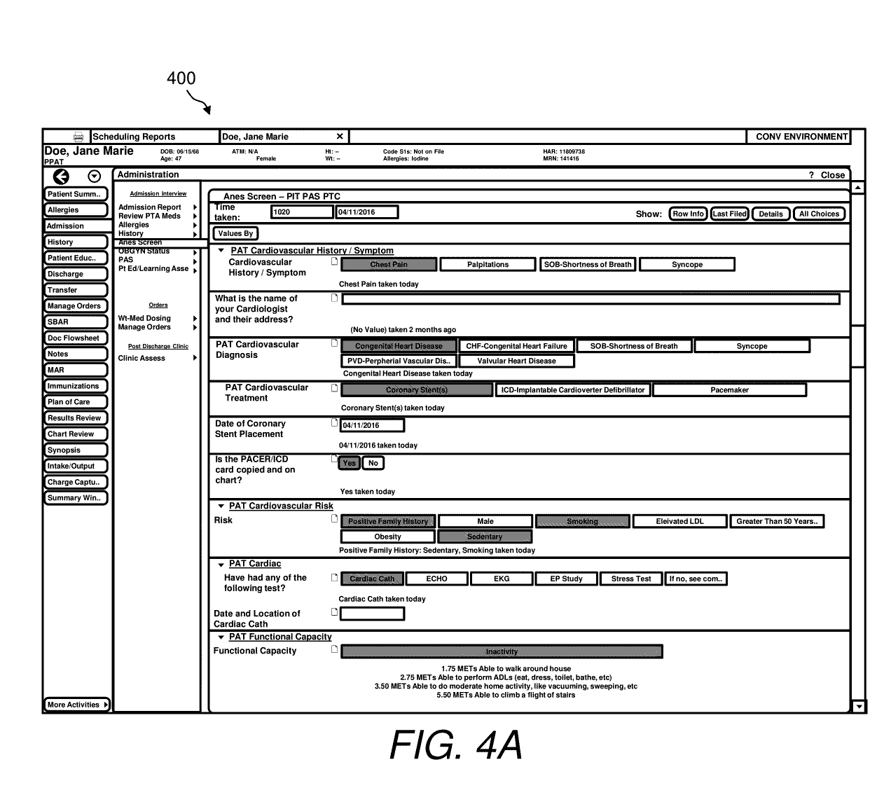

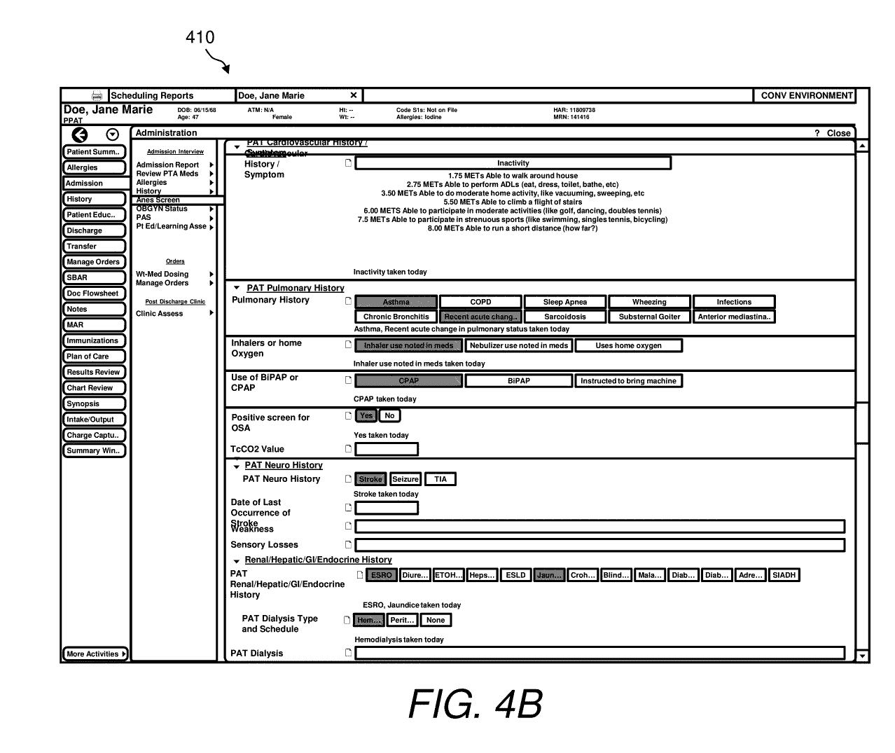

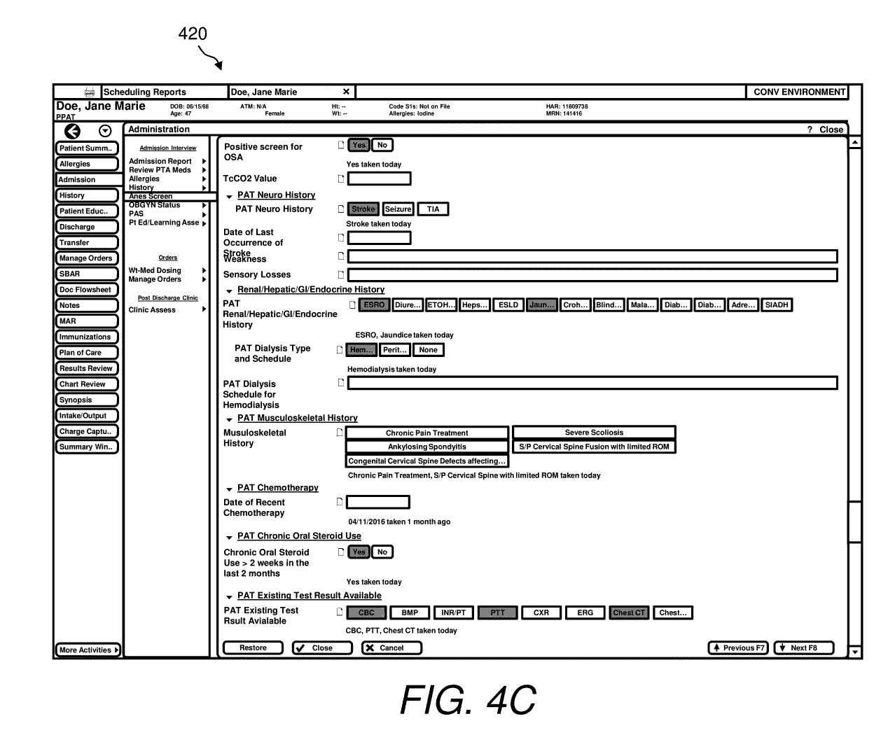

Referring to FIGS. 2A-2J, the method 200 may be initiated by an electronic surgical request 202 by a surgical office to a pre-operative (pre-op) clinic. The surgical request 202 may trigger a pre-op telephone screening 204. The pre-op telephone screening 204 may use a pre-op RN/Pt questionnaire script 206. An exemplary pre-op RN/Pt questionnaire script 106 is more fully detailed in Example 2. The pre-op RN/Pt questionnaire script 206 may be implemented via a telephone interview, a web page, an in person interview or via an in-office computerized application. An example of the web page screen shots or the in-office computerized application is illustrated by FIGS. 4A-4C and described herein.

With continued reference to FIGS. 2A-2J, the pre-op RN/Pt questionnaire script 206 may also include a screening of pre-operative medication recommendations and/or requirements as detailed in Example 3. Example 3 further describes, for example, pre-op medication counseling suggestions. One example is specific to diabetic medications. Prior to a surgical procedure, patients who may be taking diabetic medications may need to be counseled to stop taking certain medications, glipizide, glyburide, and/or glimepiride as an example. Additionally, it may be desired to schedule any patients with either type-1 or type-2 diabetes as early in the day as possible because of anticipated blood sugar changes in the patient. Additional examples may include chronic pain, anticoagulant, anti-rejection, thyroid and phentermine medications. The suggestions listed in Example 3 are exemplary and non-limiting. The suggestions detailed in Example 3 may also be incorporated into the method 200 as appropriate, being tracked via the tracking automation software.

The method 200 may include using at least one processor and memory for executing a standardized anesthesia pre-operative algorithm. The method 200 may also include determining known medical data in at least one database 118 associated with a patient. As an example, the method 200 may acquire via a user interface 110 on a computer screen, or mobile computing device 106 existing test results. The method 200 may further include acquiring known medical data from the at least one database. The method 200 may also acquire existing or known medical data via a database. The database 118 may be co-located with on the same computer device or via a network 104. The method 200 may also include querying a user for new medical data based on determining known medical data using a data entry device. The method 200 may also include determining data is one of new and known medical data. For example, if a patient has already had a required test or procedure which may be desired or even required prior to a scheduled surgery determining this and having electronic access to the test results can eliminate unnecessary costs, fees and shorten the time required to properly prepare a patient for a scheduled surgery. Additionally, in response to determining the data is one of new and/or known medical data, providing a list of appropriate medical procedures to be performed.

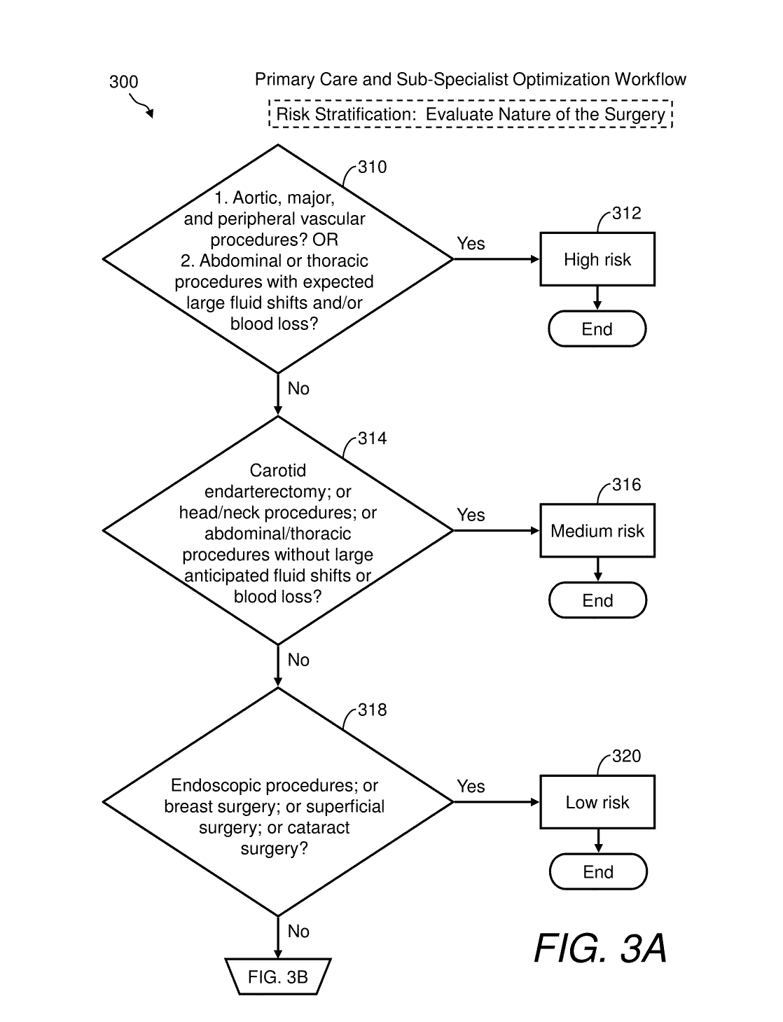

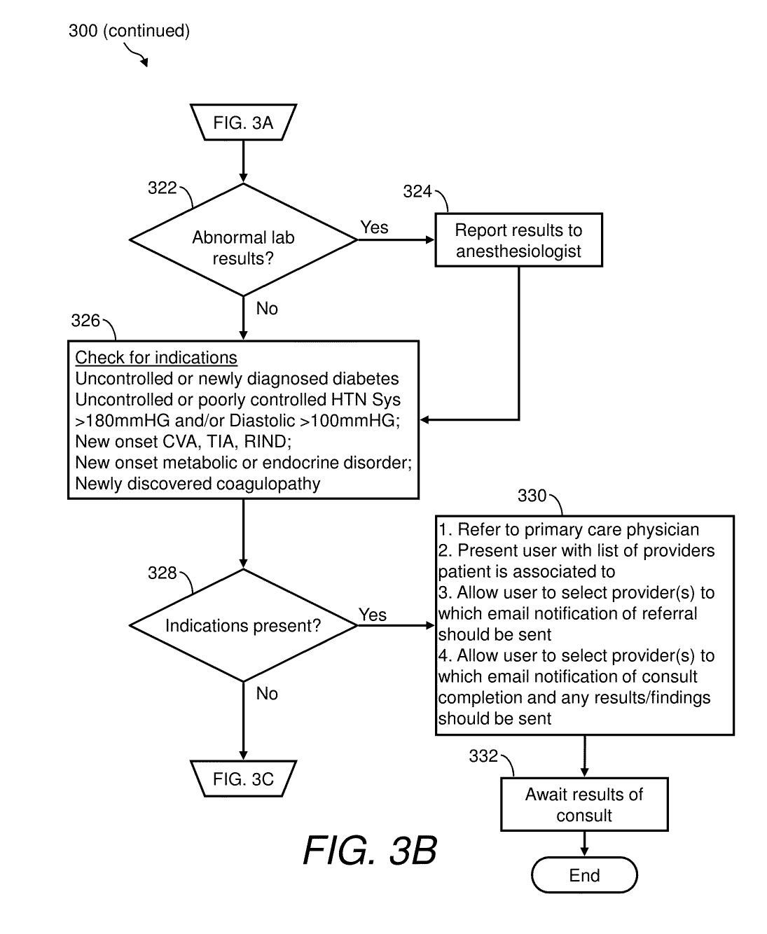

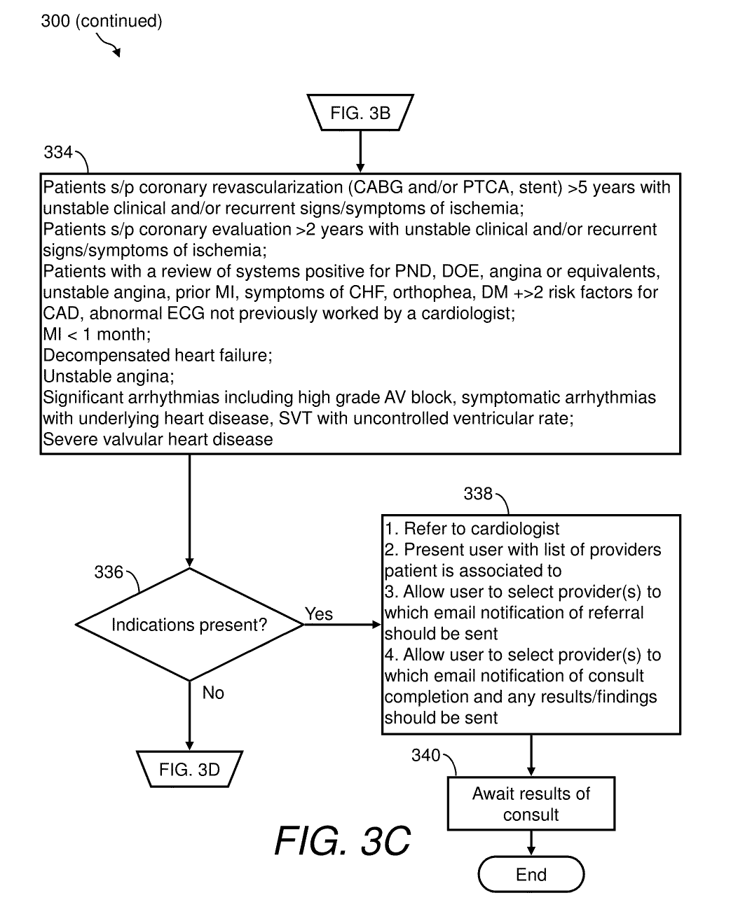

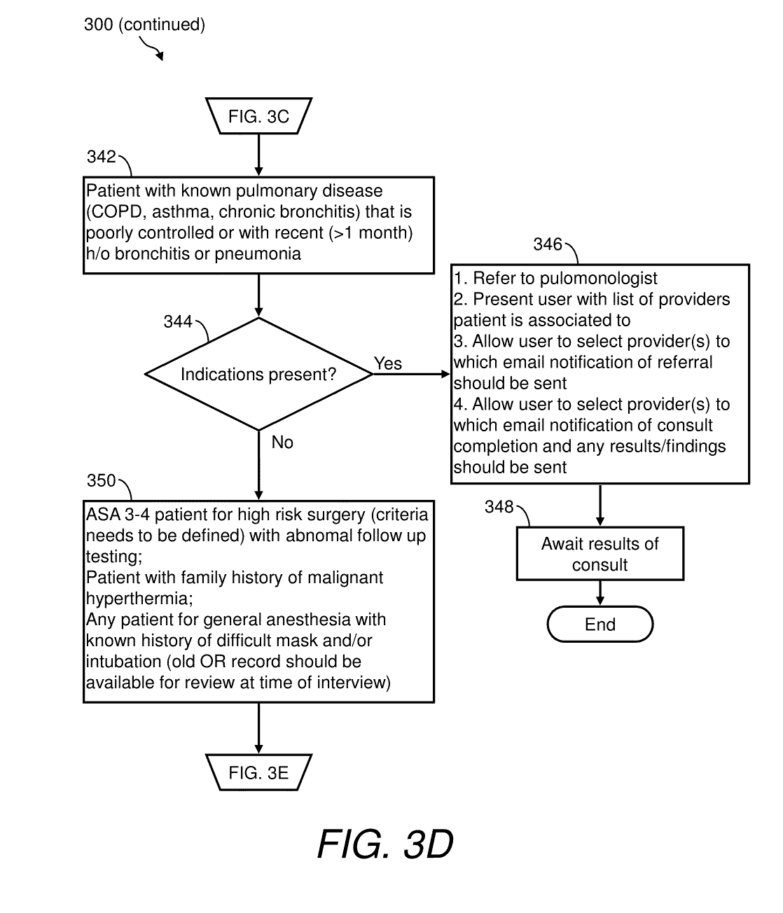

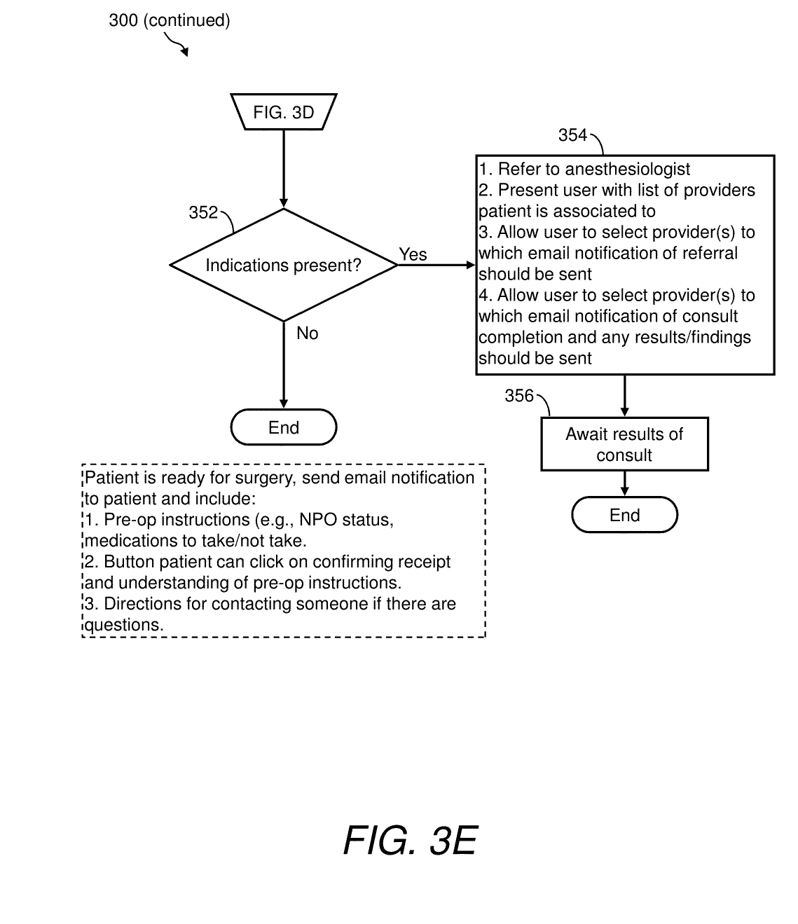

FIGS. 3A-3E illustrates a flowchart of an example method 300 for implementing anesthesiapre-operative sub-specialist optimization work flow and tracking automation with a computing device according to embodiments of the present disclosure. The method 300 is an example of a sub-specialty method for risk stratification 302 used to evaluate the risks and nature of the surgery. As an example, if the surgical procedure is aortic in nature the surgical procedure may be considered to be high risk 306. However, if the surgery is an endoscopic procedure 308 then the evaluation may be that the surgery is low risk 310. The method 300 further includes medical optimization 304 recommendations that may be desired prior to surgery. Based on various indicators 312, medical optimization prior to surgery may be recommended. It may be desired to have groupings of indications based on the nature of the recommendations. For example, based on various indicators 312, a patient may be referred to a primary care physician 312, as a non-limiting example. A referral may be made via an onscreen display, via a RN/Pt or electronically via an email to the patient and/or the referred entity (e.g., the primary care physician).

FIGS. 4A-4C is a set of screen shots 400 of an example user interface 110 for implementing anesthesia pre-operative medical evaluations and tracking automation techniques with a computing device according to embodiments of the present disclosure. The set of screen shots 400 may be used for any pre-operative medical evaluation.

Additionally referenced herein, are Examples 4-5. Example 4 is an alternative variation of Example 1. Both Example 1 and Example 4 form the basis for the flowchart illustrated in FIGS. 2A-2J and FIGS. 3A-3E.

Example 4 provides in greater detail basic pre-operative anesthesia screening suggestions for major orthopedic cases that may be included in the method 200 of FIGS. 2A-2J. It is noted that other basic pre-operative screening suggestions may be included in the method 200 of FIGS. 2A-2J and the method 300 of FIGS. 3A-3E.

Example 5 provides additional detail of the contents of a completed chart as a result of the method 100 implemented, for example, by the set of screen shots 400 stored as an electronic medical record associated with the patient. The completed chart may include physician orders, new tests ordered and additional tests results acquired, signed consents and authorizations, and various details associated with the patient, such as, name, social security number, etc.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

Although specific terms are employed herein, they are used in a generic and descriptive sense only and not for purposes of limitation. Unless otherwise defined, all technical and scientific terms used herein have the same meaning as commonly understood by one of ordinary skill in the art to which this presently described subject matter belongs.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments,±100% in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Moreover, although the term “step” may be used herein to connote different aspects of methods employed, the term should not be interpreted as implying any particular order among or between various steps herein disclosed unless and except when the order of individual steps is explicitly described.

Although the foregoing subject matter has been described in some detail by way of illustration and example for purposes of clarity of understanding, it will be understood by those skilled in the art that certain changes and modifications can be practiced within the scope of the appended claims.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to practice the methods of the present invention.

### Example 1

Pre-Op attributes Preoperative Anesthesia.

Test Center Role of RN Care Coordinators:
1. Conduct a patient interview (first via telephone then in person, if necessary) and perform a physical exam focusing on the airway, heart and lungs;
2. Screen patients for necessary preoperative tests or consults as directed by an anesthesiologist;
3. Actively find preexisting, and clinically relevant, patient data and enter it into the patients pre anesthesia record.

Role of Nurse Practitioner Evaluation:
4. ASA 3 or 4;
5. Intermediate or high risk surgery;

High risk surgery: perioperative cardiac risk>5%
1. Aortic, major and peripheral vascular procedures;
2. Abdominal or thoracic procedures with expected large fluid shifts and/or blood loss

Intermediate risk surgery: perioperative cardiac risk 1-5%
1. Carotid endarterectomy;
2. Head/neckprocedures;
3. Abdorninal/thoracic procedures without large anticipated fluid shifts or blood loss (i.e. laparoscopic surgery)
4. Orthopedic procedures;
5. Prostate surgery

Low risk surgery: perioperative cardiac risk <1%
1. Endoscopic procedures;
2. Breast surgery;
3. Superficial surgery;
4. Cataract surgery
3. Abnormal tests requiring follow up;
4. Any patient requiring primary care or sub-specialist medical optimization priorto surgery.

Indication for Preoperative Primary Care Physician Management Prior to Elective Surgery:
6, Uncontrolled or newly diagnosed diabetes;
7. Uncontrolled or poorly controlled HTN Sys>180 mmHG and/or Diastolic>110 mmHG;
8. New onset CVA, TIA, RIND;
9. New onset metabolic or endocrine disorder;
10. Newly discovered coagulopathy (i.e. protein C or S deficiency, factor VLeiden, Von Willebrands disease).

Indications for subspecialty referral:

Cardiology
11. Patients s/p coronary revascularization (CABG and/or PTCA, stent) >5 years with unstable clinical and/or recurrent signs/symptoms of ischemia
12. Patients s/p coronary evaluation>2 years with unstable clinical status and/or recurrent signs/symptoms of ischemia
13. Patients with a review of systems positive for PND, DOE, angina or equivalents, unstable angina, prior MI, symptoms of CHF, orthopnea, DM+>2 risk factors for CAD, abnormal ECG not previously worked by a cardiologist
14. MI<1 month
15. Decompensated heart failure
16. Unstable angina.
17. Significant arrhythmias including high grade AV block, symptomatic arrhythmias with underlying heart disease, SVT with uncontrolled ventricular rate
18. Severe valvular heart disease.

Pulmonary
19. Patient with known pulmonary disease (COPD, asthma, chronic bronchitis) that is poorly controlled or with recent (>1 month) h/o bronchitis or pneumonia.
20. Other indications?

Indications for an Anesthesiologist evaluation:
21. ASA 3-4 patient for High Risk Surgery (criteria needs to be defined) with abnormal follow up testing;
22. Patient with family history of malignant hyperthermia;
23. Any patient for General Anesthesia with known history of difficult mask and/or intubation (old OR record should be available for review at time of interview).

Cataracts done under MAC are exempt from the following testing. Labs and tests for a “complete” anesthesia pre-op
24. CBC
25. Chem 7
26. Chest X-Ray (CXR)
27. EKG

Possible additional labs and tests:
28. PT/PTT/INR
29. ABG
30. C-Spine films
31. PFTs
32. Urine pregnancy test

Guidelines and equivalents for aforementioned tests:

CBC—normal CBC good for 6 months with a patient history negative for significant recent (i,e. >2 weeks) blood loss i.e. intermediate to high risk surgery, GI bleed, etc)

Indications:
33. Cardiovascular disease;
34. CKD/ESRD or active hepatic disease;
35. History of anemia;
36. Current anticoagulant use or known bleeding disorder;
37. Procedure requiring a type and screen or crossmatch;
38. Intermediate or high risk surgery;
39. Recent chemotherapy;
40. ETOH abuse;
41. Severe COPD (>2 respiratory meds and on home O2);
42. Pregnancy.

Notify anesthesiologist for HgB<8, HCT<24, WBC>15 K or <2.5 K, plts <100 K

Chem 7-normal Chem 7 good for 6 months in patient with history negative for recent diuretic medication change and compliant with medicationregimen

Indications:
43. Cardiovascular disease;
44. Endocrine disease (SIADH, DI, DM, Adrenal disease);
45. CKD, ESRD, end stage liver disease;
46. Diuretics use;
47. Chronic oral steroid use (>2 weeks duration within last 2 months);
48. Malabsorption symptoms (i.e. Crohns disease, Blind Loop syndrome)
49. Known metabolic disorder
50. BMI>40 or less<17

Notify anesthesiologist for Na+<130 or >150, Cr>1.9, GFR<35, glucose non-diabetic>180, NIDDM>250, IDDM<80 or >250, K+<3.0 or >5.5

Chest X-Ray (CXR)—normal CXR good for 24 months in patient with history negative for acute (<1 week) change in respiratory status including suspected pneumonia, COPD Every attempt should be made by care coordinator to find a CXR or equivalent (chest CT, MRI) test in the patients existing clinical record especially for patients with a history of:
51. Scheduled cardiovascular or thoracic surgery;
52. History of COPD (asthma, emphysema, or chronic bronchitis);
53. Substernal goiter or anterior mediastinal mass;
54. History of restrictive lung disease;
55Acute change in functional pulmonary status.

Have results available for anesthesiologist to review.

EKG previous normal EKG good for 6 months in patient with a history negative for cardiac symptoms, decrease in functional capacity and no intervening cardiac diagnosis.

The care coordinator will attempt to find pertinent information in the patientrecord before ordering a new test.

All patients will be asked questions by the care coordinator to determine:
54. The patient's functional capacity;
55. Presence or absence of cardiac related symptoms (angina, palpitations, syncope, PND) either with activity or at rest;
56. Any previous cardiac testing (stress test, echocardiogram, cardiac catheterization, Holter Monitor) or procedure (PTCA/stent, ablation, cardiac surgery). If positive, who was the cardiologist or surgeon and theircontact information.

EKG Indications:
57. Known cardiac disease (cardiomyopathy, ascvd, congenital heart disease) or complaints;
58. h/o CHF, palpitations, syncope, valvular heart disease, pacemaker or AICD;
59. Stroke, TIA, PVD;
60. Diabetes on meds;
61. h/o respiratory failure, COPD, OSA;
   62.2 or more risk factors for CAD (+family history, smoking, elevated LDL, male, age >50, obesity, sedentary lifestyle).

Notify anesthesiologist of the following new EKG findings:
63. infarct
64. ischemia
65. ST depression/elevation
66. HR<40 or >120
67. Undetermined rhythm

Coagulation studies
PT/INR 1. Coumadin use

2. Active hepatic or renal disease in patient scheduled for intermediate or high risk surgery
PTT 1. Heparin use

2. Active hepatic or renal disease in patient scheduled for intermediate or high risk surgery

Notify anesthesiologist for INR >1.2 or PTT>40 in case where patient is acandidate for a regional anesthetic.

Arterial Blood Gas—Indications:
68. Positive STOP questionnaire
69. CPAP noncompliance in patient with known OSA

(can get room air ABG on an as needed basis in the pre-op holding area).

C-Spine films, or there equivalent (CT, MRI) are rarely indicated but may be necessary in the following scenarios:
70. Rheumatoid Arthritis affecting cervical ROM
71. Ankylosing spondylitis
72. Severe scoliosis
73. Congenital cervical spine defects affecting ROM
74. Status post multilevel cervical fusion with limited ROM

Affected patients most likely have existing films, these should be found in theexisting record before ordering new films.

Pulmonary Function Tests (PFTs) are rarely necessary. When indicated, these tests can often be found in the existing patient record Every effort should be made by the care coordinator to find these results and the anesthesiologist should be consultedprior to ordering this test.

Indications:
75. Patients undergoing pneumonectomy;
76. Patients with severe restrictive lung disease for high risk surgery

Urine pregnancy test is indicated for all premenopausal women of child bearing age and can be performed in the preop holding area.

Proposed patient flow:
76. Surgery scheduled
77. Patient demographic information sent from surgeon's office to pre-op clinic
78. Over the phone screening questionnaire by pre-op clinic RN
   a) does the patient need to come to the clinic for an evaluation?
   b) what labs/tests are required for the surgery?
   c) do these labs/tests already exist in the patient's record? Are the results still clinically relevant?

Patients will fall into three subgroups:

Group A)—no clinic visit required, labs/tests exist and are relevant - - - proceed with surgery;

Group B)—no clinic visit required, labs/tests do not exist - - - obtain labs and, if appropriate, proceed with surgery;

Group C)—in clinic visit required, schedule pre-op evaluation

### Example 2

Pre-operative RN/Pt questionnaire script Purpose: To determine
1. Whether a surgical candidate requires an in-clinic evaluation is necessary;
2. What labs/tests are necessary; and
3. Whether those tests exist in an database and are clinically relevant.

Patients demographic info (name, DOB, etc).

RN questions during initial telephone interview:
1. Name, proposed procedure and surgeon?
2. Have you ever had surgery or anesthesia before? If so, what and when? have you or anyone in your family ever had problems with anesthesia before? If so, what problem?
3. Do you have a PCP? If so, who?
4. Do you have any other health problems?If so, what problems?
5. Do you have high blood pressure? If so, wthat medicines do you take?
6. Do you have diabetes? If so, what medicines do you take?
7. Do you have any problems with your heart or lungs?
8. Have you ever had a heart attack? How active are you at home? Do you have problems with chest pain or shortness of breath?
9. If you answered yes to questions 6 or 7, who is your cardiologist? What heart tests have you had (EKG, stress test, echo, cardiac cath, cabg)?
10. Do you have problems with your lungs-specifically asthma, COPD or Obstructive Sleep Apnea (OSA)? If you have asthma or COPD, do you use inhalers or homeO2? Have you had any recent problems with your lungs, specifically wheezing or infections? If you have OSA, do you use a CPAP or BiPAP machine?
11. STOP ?s: Do you snore loudly?
   Are you tired during the day?
   Has anyone observed you stop breathing during sleep?
   Do you have high blood pressure?
   Two positive answers and BMI>40 pt needs TCO2 with results documented on chart.
11. Do you have any problems with your kidneys or liver? if so, what problems?
12. If patient has end stage renal disease (ESRD), are they on dialysis? If so, whattype and schedule?
13. Any problems with hepatitis or yellow jaundice?
14. Have you ever had a seizure or stroke? If so, when? Any residuals—weakness, sensory loss?
15. Airway exam

### Example 3

Diabetic Meds:
1. Attempt to schedule any patients with either type 1 or 2 diabetes as early in the day as possible.
2. Hold all oral diabetes medications the morning of surgery. These drugs include:
   Sulfonylureas (glipizide, glyburide, glimeperide)
   Biguanides (metformin)
   Thiazolidinediones (pioglitizone, rosiglitazone)
   Dipeptidyl peptidase inhibitors (stitagliptin, alogliptin, saxagliptin, linaglipt
   Alpha-glucosidase inhibitors (acarbose, miglitol)
3. Patients taking long acting insulin (Lantus, NPR, etc) should take 75% of their normal evening dose the night before surgery and 50% of their normal dose the morning of surgery.
4. No short acting insulin the morning of surgery unless directed by an anesthesiologist.
5. Maintain basal insulin infusions via an insulin pump until the patient is seen by an anesthesiologist.

Chronic Pain Meds:
1. May take all chronic pain medicines (except suboxone and butrans patch) the morning of surgery.
2. Suboxone should be taken though the evening before surgery. Do not take the day of surgery.
3. Butrans patch should be removed the day before surgery. Physician prescribing the butrans patch should be contacted and asked to write for a bridge dose of a pure opioid agonist (ie. oxycodone).

Anticoagulant Meds:
1. Coumadin should be held for 5 days prior to surgery. PT/INR will be checked the morning of surgery
2. Plavix should be held for 7 days prior to surgery. Contact an anesthesiologist for any patient on Plavix secondary to cardiac stent placed within 1 year of scheduled surgery date.
3. Pradaxa (dabigatran) should be held 24 hours prior to minor surgery, 48 hours for major surgery.
4. Xaralto (rivaroxaban) should be held 48 hrs prior to surgery.
5. Eliquis (apixaban) should be held 48 hrs prior to surgery.
6. Brilinta (ticagrelor) should be held for 72 hrs prior to surgery. Effient (prasugrel should be held for 10 days prior to surgery.

Anti-Rejection Meds:
1. May take the day of surgery.

Thyroid Meds:
1. May take the day of surgery.

Phentermine
1. Do not take for one week.

### Example 4

Preoperative Anesthesia Test Center and Perioperative Beta Blockade Guidelines

The content of the preanesthetic evaluation includes but is not limited to:
1. Accessible Medical Records from all pertinent sources prior to date of surgery
2. Patient Interview
3. Directed preanesthesia exam with emphasis on airway, lungs, heart
4. Preoperative tests
5. Consults when warranted
A. Indications for Nurse Only Evaluation
   1. ASA I or II
   2. No abnormal test
   3. Normal airway exam
   4. Intermediate or Low Risk Surgery
   5. No prior history of Anesthesia difficulties
B. Indication for Nurse Practitioner Evaluation
   1. ASA III or IV
   2. Intermediate or High Risk Surgery
   3. Abnormal tests requiring follow up
   4. Any patient requiring primary care physician follow up prior to surgery for optimization
   5. Any patient with testing performed at outside facility whose results could impact surgery
C. Indications for Anesthesiologist Evaluation p1 1. ASA III or IV patient scheduled for High Risk Surgery with abnormal follow up testing
   2. Patient with family history of Malignant Hyperthermia
   3. Any patient for General Anesthesia with know history of difficult mask and/or intubation
   4. Patients with functional status<4 METS despite medical optimization
D. Indications for Preoperative ECG
   1. 2 or more risk factors for CAD:+family history, smoking, elevated LDL cholesterol, male, age>50, Obesity, Sedentary lifestyle
   2. Diabetes Mellitus
   3. Known CAD
   4. Angina
   5. History of MI, prio PTCA, cardiac catheterization, physical or chemical stress testing. Holter monitoring
   6. History of Palpitations
   7. History of CHF
   8. History of Valvular Disease or surgery (especially stenosis)
   9. History of Dysrythmias/Arythmia: atrial fibrillation/flutter, SVT, WPW
   10. Pacemaker/AICD
   11. History of Syncope
   12. History of Respiratory Failure
   13. History of Peripheral Vascular Disease
   14. Obstructive Sleep Apnea
   15. Chronic Obstructive Pulmonary Disease
   16. Emphysema
   17. Orthopnea
   18. Dyspnea at<5 METS
   19. History of Congenital Heart Disease
   20. History of Cardiomyopathy
   21. Lupus
   22. Known metabolic or vitamin deficiencies
   23. Breast, lung, liver pancreatic cancer
   24. All HIV positive patients on antiretrovirals
E. Indications for Preoperative Chest X-Ray
   1. Cardiovascular or Thoracic Surgery
   2. Acute change in functional or pulmonary status
   3. History of COPD, Emphysema, Chronic Lung Disease or suspicion of active pneumonia
   4. Significant cardiac disease
   5. Substernal goiter or anterior mediastinal mass
   6. Severe scoliosis or restrictive lung disease
   7. Ankyklosing Spondylitis, Rheumatoid Arthritis affecting thoracic/cervical spine
F. Indication for Preoperative CBC
   1. Intermediate or High Risk Surgery
   2. History of Anemia
   3. Pregnancy
   4. Known Bleeding Disorders
   5. Cancer with active Chemotherapy
   6. End Stage Liver or Kidney Disease
   7. Recent GI bleed or Colon Cancer
G. Potential Indications for Preoperative C-Spine Films
   1. Rheumatoid Arthritis affecting cervical ROM
   2. Ankylosing Spondylitis
   3. Severe Scoliosis
   4. Congenital Defects affecting cervical fusion with limited ROM
   5. Status Post multilevel cervical fusion with limited ROM
H. Indications for Preoperative Coagulation Studies
   1. Any patient requiring neuraxial anesthesia for surgery or postoperative pain control
   2. Patients on Coumadin or IV Heparin
   3. Patients with known bleeding disorders, history of abnormal bleeding with and/or without surgery
   4. Patients followed by a Hematologist
   5. Patients scheduled for high risk surgery (Thoracic, Major Vascular, Cardiac, Liver, Pancreatic, Major Spine, Neurosurgery)
   6. Patients with End Stage Liver Disease scheduled for Intermediate or High Risk Surgery.
   7. Patients with End Stage Renal Disease scheduled for Intermediate or High risk Surgery
I. Indication for Preoperative Chem 7 (or portions thereof)
   1. Endocrine disorders: SIADH, Diabetes Insipidus, Diabetes Mellitus, Parathyroid disorders, Adrenal Disease (Addisons Cushings)
   2. End Stage Renal Disease
   3. End Stage Liver Disease
   4. Patients on Diuretics (especially Thiazides)
   5. Patiens with Malabsorption Syndromes, Crohn's Disease, Blind Loop Syndrome
   6. Patients with known metabolic disorders especially with respect to Na+, K+, Ca++, Mg++
J. Indications for Preoperative Urine Pregnancy Testing
   1. All premenopausal women of child bearing age
K. Indications for Preoperative Arterial Blood Gas
   1. Gastric restrictive procedures
   2. Untreated or noncompliant Obstructive Sleep Apnea patients for intermediate or High Risk Surgery
   3. Patients with O2 dependent lung disease for intermediate or High Risk Surgery
L. Indications for Preoperative PFTs
   1. Patients undergoing Pneumonectomy
   2. Patients with severe restrictive lung disease for high Risk Surgery
M. Indications for Preoperative Hgb A1C
   1. All patients with known diabetes
N. Indications for Preoperative Beta Blockade
   1. Patients on beta blocker theropy prescribed prior to surgery
   2. Patients with a history of recent MI
O. Contraindications to Perioperative Beta Blockade
   1. Bradycardia
   2. Heart Block
   3. Severe Hypotension (Systolic<100 mmHg)
   4. Decompensated Heart Failure
   5. Severe asthmatics/COPD for nonselective blockade
P. Indications for further testing and/or cardiology follow up in patients with known CAD for non-cardiac surgery
   1. Patients status post coronary revascularization>5 years with unstable clinical status and/or recurrent signs/symptoms of ischemia
   2. Patients status post coronary evaluation>2 years with unstable clinical status and/or recurrent signs/symptoms of ischemia
   3. Patients with+review of symptoms for PND, DOE, angina or equivalents, unstable angina, prior MI, symptoms of CHF, orthopnea, DM+>2 risk factors for CAD, abnormal ECG not previously worked up by a Cardiologist
   4. MI<1 month
   5. Decompensated heart failure (acute or poorly controlled)
   6. Unstable angina
   7. Significant Arrythmias including high grade A-V block, symptomatic arrythmias with underlying heart disease, supraventricular arrythmias with uncontrolled ventricular rate
   8. Severe Valvular Disease (especially stenotic lesions)

Invasive testing may be indicated in light of abnormal non-invasive test results or in patients w/poor functional capacity scheduled for high risk surgery.

PTCA and CABG are reserved for patients who would require such interventions regardless of their need for elective surgery.
Q. Indications for preoperative. Primary Care. Physician management prior to elective surgery
   1. Uncontrolled or newly diagnosed Diabetes
   2. Uncontrolled or poorly controlled HTN Sys>180 mmHG Diastolic>110 mmHg
   3. New onset CVA, TIA, RIND
   4. New onset metabolic or endocrine disorder
   5. Newly discovered coagulopathy of bleeding disorder such as Protein C or S deficiency, Factor V Leiden, Bon Willebrand's Disease
R. Contraindications to Exercise or Pharmacological Stress Testing
   1. For exercise stress tests: diagnosis of patients with resting ECG abnormalities that preclude adequate assessment, i.e. Pre-excitation syndrome, paced ventricular rhythm, LBBB, digitalis effect, resting ST segment depression>1 mm
   2. Severe comorbidity likely to limit life expectancy or candidacy for revascularization
   3. Routine screening of asymptomatic patients
   4. Investigation of isolated ectopic beats in young patients
S. Contraindications for Coronary Angiography
   1. Low risk non-cardiac surgery with known CAD in patients without positive results for ischemia on noninvasive testing
   2. Mild stable angina with good. LV function in patients without positive ischemic findings on noninvasive test results
   3. Non-candidates for revascularization secondary to comorbidity or patient refusal
   4. Patients<40 years old for liver, lung, renal transplantation as part of transplant evaluation process
   5. Asymptomatic patients after coronary revascularization with exercise capacity>6 METS
T. High Risk Surgery: Perioperative Cardiac Risk>5%
   1. Emergency operations (Major especially in elderly patients)
   2. Aortic and major vascular procedures
   3. Peripheral vascular procedures
   4. Abdominal or thoracic procedures with expected large fluid shifts and/or blood loss
U. Intermediate Risk Surgery: Perioperative Cardiac Risk 1-5%
   1. Carotid Endarterectomy
   2. Head/neck procedures
   3. Abdominal/thoracic procedures without large fluid shifts or blood loss
   4. Orthopedic procedures
   5. Prostate surgery
V. Low Risk Surgery: Perioperatove Cardiac Risk<1%
   1. Endoscopic Procedures
   2. Breast Surgery
   3. Superficial Procedures
   4. Cataract Surgery

### Example 5

### Completed Chart Includes

1. Manual physician orders include the admitting physician, patient status, diagnosis, and are timed/dated/signed.
2. Ordered and appropriate test results are available and are within an acceptable range and time frame.
3. The H&P is current (within 30 days), dated and signed.
4. The surgical consent has no abbreviations and is completed appropriately (i.e. signed, witnessed, dated, timed, and R/B/A signed/dated/timed by surgeon unless included in H&P).

5. The blood consent (as applicable) is dated, timed and all appropriate sections are complete (i.e. signed/witnessed and names printed including explaining physician's signature and printed name)

(below are additional tasks performed to assure the patient's record is ready for the day of surgery)
6. The patient armband has the correct name, MR#, HAR# and is present on the chart.
7. Applicable patient allergy stickers have been applied to the front of the chart.
8. Applicable patient allergies/concerns have been recorded in the OR schedule notes section.
9. Applicable sections of the surgical checklist are completed in the EHR.
10. The patient account number and pending encounter date are correct in the EHR.
11. The H&P (as applicable) is scanned into the EHR.
12. Manual physician orders are scanned to the Pharmacy.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

What is claimed:

1. A method comprising:
using at least one processor and memory for:
executing a standardized anesthesia pre-operative algorithm;
determining known medical data in at least one database associated with a patient;
acquiring known medical data from the at least one database;
querying a user for new medical data required based on determining known medical data using a data entry device;
determining data is one of new and known medical data; and
in response to determining the data is one of new and known medical data, providing a list of appropriate medical procedures to be performed.

2. The method of claim 1, wherein the data entry device is a wireless mobile device.

3. The method of claim 1, further comprising receiving an electronic surgical request to initiate executing the standardized anesthesia pre-operative algorithm.

4. The method of claim 1, further comprising determining the source for the known data.

5. The method of claim 1, further comprising determining what medical conditions are present in the patient.

6. The method of claim 1, further comprising receiving electronic medical data from one of an x-ray, a cat scan and a magnetic resonance imaging device.

7. A system comprising:
at least one processor and memory; and
a standardized anesthesia pre-operative module configured to:
execute a standardized anesthesia pre-operative algorithm;
determine known medical data in at least one database associated with a patient;
acquire known medical data from the at least one database;
query a user for new medical data based on determining known medical data using a data entry device;
determine data is one of new and known medical data; and
in response to determining the data is one of new and known medical data, provide a list of appropriate medical procedures to be performed.

8. The system of claim 7, wherein the data entry device is a wireless mobile device.

9. The system of claim 7, further comprising receiving an electronic surgical request to initiate executing the standardized anesthesia pre-operative algorithm.

10. The system of claim 7, further comprising determining the source for the known data.

11. The system of claim 7, further comprising determining what medical conditions exist.

12. The system of claim 7, further comprising receiving electronic medical data from one of an x-ray, a cat scan and a magnetic resonance imaging device.

13. A computer program product for implementing a feature at a computing device, said computer program product comprising:
a non-transient computer readable storage medium having computer readable program code embodied therewith, the computer readable program code comprising:
computer readable program code configured to execute a standardized anesthesia pre-operative algorithm;
computer readable program code configured to determine known medical data in at least one database associated with a patient;
computer readable program code configured to acquire known medical data from the at least one database;
computer readable program code configured to query a user for new medical data based on determining known medical data using a data entry device;
computer readable program code configured to determine data is one of new and known medical data; and
computer readable program code configured to provide a list of appropriate medical procedures to be performed in response to determining the data is one of new and known medical data.

14. The computer program product of claim 13, wherein the measure is a measure of user productivity at a computing device.

15. The computer program product of claim 13, wherein the data entry device is a wireless mobile device.

16. The system of claim 13, further comprising receiving an electronic surgical request to initiate executing the standardized anesthesia pre-operative algorithm.

17. The system of claim 13, further comprising determining the source for the known data.

18. The system of claim 13, further comprising determining what medical conditions exist.

19. The system of claim 13, further comprising receiving electronic medical data from one of an x-ray, a cat scan and a magnetic resonance imaging device.
